(19) United States
(12) Patent Application Publication
(10) Pub. No.: US 2012/0180038 A1
(43) Pub. Date: Jul. 12, 2012

(54) SYSTEM AND METHOD FOR UPGRADING FIRMWARE OF A PRINTED CIRCUIT BOARD

(75) Inventor: MING-XIANG HU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/217,290

(22) Filed: Aug. 25, 2011

(30) Foreign Application Priority Data
Jan. 12, 2011 (CN) 201110005810.2

(51) Int. Cl. G06F 9/44

(52) U.S. Cl. 717/173

(57) ABSTRACT

A printed circuit board (PCB) includes a microcontroller and a plurality of firmware. The microcontroller determines which firmware to be upgraded according an update code of an update request received by a radio frequency device of the PCB. If the microcontroller is in an update mode, the server sends an update file of the determined firmware to the microcontroller. The microcontroller upgrades the determined firmware according to the update file.

### BACKGROUND

1. Technical Field

Embodiments of the present disclosure generally relate to firmware management, and particularly to a firmware update system and method.

2. Description of Related Art

Firmware is a collection of programs and/or data structures that internally control various electronic devices. Firmware upgrading of a printed circuit board (PCB) can solve problems such as bugs and compatibility of the PCB. To perform the upgrading, the PCB must be powered on. If the PCB is powered off, the upgrading may be interrupted.

### BRIEF DESCRIPTION OF THE DRAWINGS

FIG. 1 is a block diagram of one embodiment of a microcontroller of a printed circuit board (PCB) comprising a update system.

FIG. 2 is a block diagram of one embodiment of the function modules of the update system in FIG. 1.

FIG. 3 is a flowchart illustrating one embodiment of a method for upgrading firmware of the PCB.

### DETAILED DESCRIPTION

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

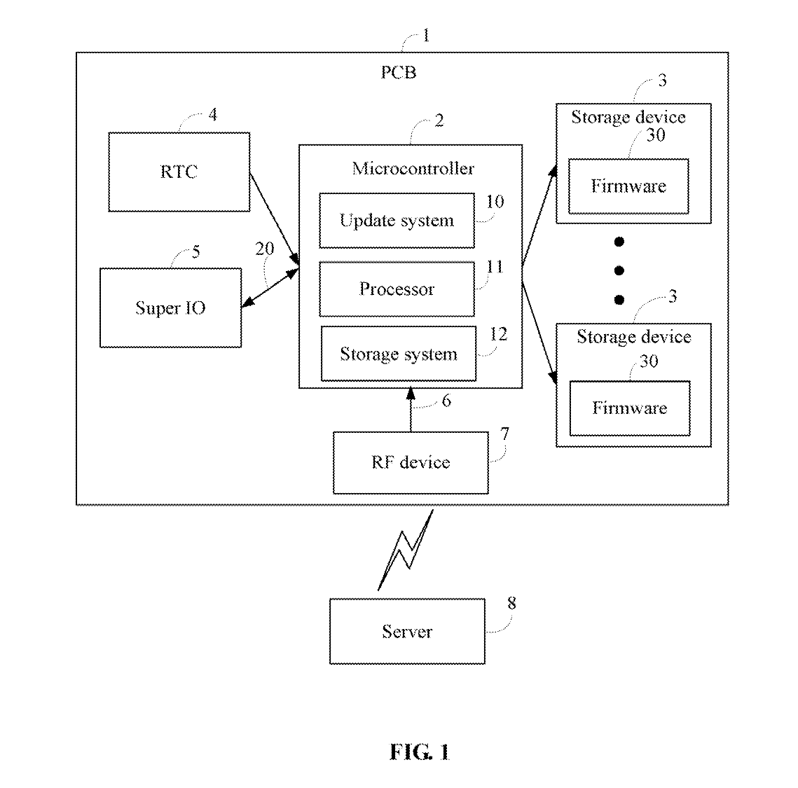

FIG. 1 is a block diagram of one embodiment of a microcontroller 2 comprising an update system 10. The microcontroller 2 is installed in a printed circuit board (PCB) 1, and is electrically connected to a plurality of storage devices 3. Each storage device 3 stores at least one firmware 30. In some embodiments, the storage device 3 may be an erasable programmable ROM (EPROM). The firmware 30 may be a basic input output systems (BIOS). The update system 10 is used to upgrade the firmware 30. Upgrading is understood as a process to update one of more software components in the firmware 30 to a newer version.

The microcontroller 2 is electrically connected to a real-time clock (RTC) battery 4. The RTC battery 4 supplies power to the microcontroller 2 if the PCB 1 is powered off. The microcontroller 2 connects with a super input output (super IO) chip 5 via a control signal wire 20. Determination of if the firmware has been upgraded is according to an electrical level of the control signal wire 20. In one embodiment, the electrical levels includes a high level and a low level. The high level may be logic 1 to designate that firmware has been upgraded. The low level may be logic 0 to designate that the firmware has not been upgraded.

The microcontroller 2 is further connected to a radio frequency (RF) device 7 via a universal asynchronous receiver/transmitter (UART) serial port 6. The RF 7 connects with a server 8 via a wireless network. In one embodiment, the server 8 may be a computer, an adapter, or other electrical device. The server 8 stores an update file of each firmware 30 (i.e., an updated version of the firmware 30). The RF 7 receives the update files sent from the server 8, and sends the update files to the microcontroller 2 via the UART serial port 6. The update system 10 upgrades each firmware 30 according to the update file of the firmware 30.

In an exemplary embodiment, the microcontroller 1 includes at least one processor 11 and a storage system 12. The update system 10 may include one or more modules. The one or more modules may comprise computerized code in the form of one or more programs that are stored in the storage system 12 (or memory). In one embodiment, the storage system 12 may be a magnetic or an optical storage system, such as a flash. The computerized code includes instructions that are executed by the at least one processor 11 to provide functions for the one or more modules.

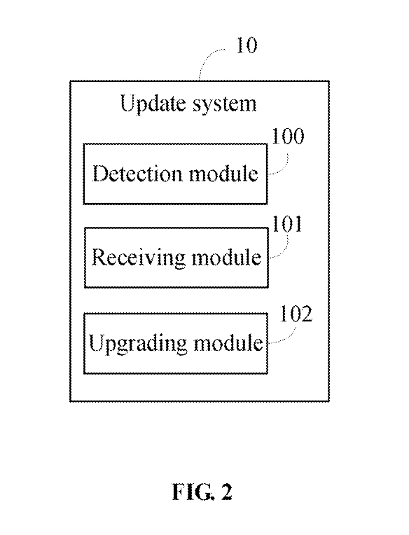

As shown in FIG. 2, the update system 10 may include a detection module 100, a receiving module 101, and an upgrading module 102.

The detection module 100 detects if the RF 7 receives a request from the server 8 to upgrade the firmware 30 to a newer version (“update request”). It should be understood that electromagnetic interference may affect the wireless network, causing the RF 7 to receive invalid requests from the server 8. So, the update request includes an update code. Each unique update code corresponds to a firmware 30. For example, if the update code is “0”, the corresponding firmware 30 to update is the BIOS.

If the RF 7 receives the update request from the server 8, the detection module 100 further detects if the microcontroller 2 is in an update mode according to the electrical level of the control signal wire 20. If the microcontroller 2 is in the update mode, the microcontroller 2 upgrades each firmware 30. In some embodiments, if the PCB 1 is powered on and the electrical level of the control signal wire 20 is in the high level, or if the PCB 1 is powered off and the electrical level of the control signal wire 20 is in the high level, the microcontroller 2 is determined as being in the update mode. If the PCB 1 is powered on and the electrical level of the control signal wire 20 is in the low level, or if the PCB is powered off and the electrical level of the control signal wire 20 is in the low level, the microcontroller 2 is determined as not being in the update mode.

If the microcontroller 2 is determined to be in the update mode, the receiving module 101 determines a firmware 30 to be upgraded according to the update code in the update request. In another embodiment, the update request may not contain the update code. The update code can be obtained by the RF 7 from the server 8.

The receiving module 101 receives the update file of the determined firmware 30 from the server 8.

The upgrading module 102 upgrades the determined firmware 30 according to the update file of the determined firmware 30, and uploads a result of upgrading the determined firmware 30 to the server 8 via the FR 7. In one embodiment, the result may include success or failure in upgrading the determined firmware 30 to the server 8 via FR 7, and reasons of the failure.

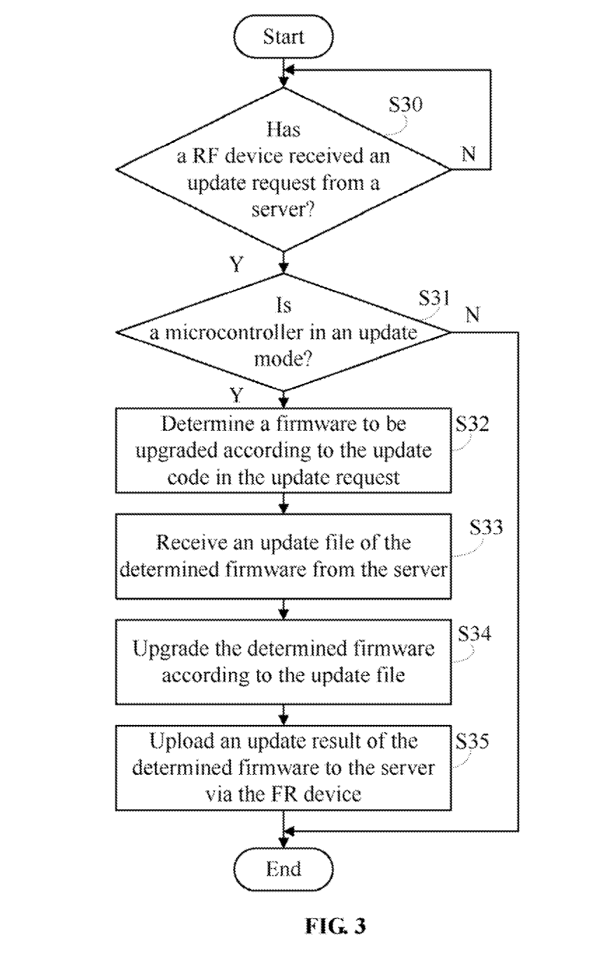

FIG. 3 is a flowchart illustrating a method for upgrading firmware of the PCB 1. Depending on the embodiment, additional blocks may be added, others removed, and the ordering of the blocks may be changed.

In block S30, the detection module 100 detects if the RF 7 has received an update request from the server 8. If the RF 7 has received the update request from the server 8, block S31 is implemented. If the RF 7 has not received the update request from the server 8, block S30 is repeated.

In block S31, the detection module 100 detects if the microcontroller 2 is in an update mode according to the electrical level of the control signal wire 20. In some embodiments, if the PCB 1 is powered on and the electrical level of the control signal wire 20 is in the high level, or if the PCB 1 is powered off and the electrical level of the control signal wire 20 is in the high level, the microcontroller 2 is determined as being in the update mode. If the PCB 1 is powered on and the electrical level of the control signal wire 20 is in the low level, or if the PCB is powered off and the electrical level of the control signal wire 20 is in the low level, the microcontroller 2 is determined as not in the update mode. If the microcontroller 2 is in the update mode, block S32 is implemented. If the microcontroller 2 is not in the update mode, the procedure ends.

In block S32, the receiving module 101 determines a firmware 30 to be upgraded according to the update code in the update request.

In block S33, the receiving module 101 receives the update file of the determined firmware 30 from the server 8.

In block S34, the upgrading module 102 upgrades the determined firmware 30 according to the update file of the determined firmware 30.

In block S35, the upgrading module 102 uploads a result of upgrading the determined firmware 30 to the server 8 via the FR 7.

Although certain inventive embodiments of the present disclosure have been specifically described, the present disclosure is not to be construed as being limited thereto. Various changes or modifications may be made to the present disclosure beyond departing from the scope and spirit of the present disclosure.

What is claimed is:

1. A microcontroller of a printed circuit board (PCB), comprising:
a storage system;
at least one processor; and
one or more programs being stored in the storage system and executable by the at least one processor, the one or more programs comprising:
a receiving module operable to determine a firmware of the PCB to be upgraded according to an update code in an update request received by a radio frequency (RF) device when the microcontroller is in an update mode;
the receiving module further operable to receive an update file of the determined firmware from a server via the RF device; and
an upgrading module operable to upgrade the determined firmware according to the update file, and upload a result of upgrading the determined firmware to the server via the RF device.

2. The microcontroller as described in claim 1, wherein the microcontroller connects with a super input/output (IO) via a control signal wire.

3. The microcontroller as described in claim 2, further comprising: a detection module operable to detect if the microcontroller is in the update mode according to an electrical level of the control signal wire.

4. The microcontroller as described in claim 3, wherein the microcontroller is determined in the update mode if the PCB is powered on and the electrical level of the control signal wire is in a high level or if the PCB is powered off and the electrical level of the control signal wire is in the high level.

5. The microcontroller as described in claim 3, wherein the microcontroller is determined not in the update mode if the PCB is powered on and the electrical level of the control signal wire is in a low level or if the PCB is powered off and the electrical level of the control signal wire is in the low level.

6. The microcontroller as described in claim 1, wherein the result comprises confirmation of upgrading success or upgrading failure and reasons of the upgrading failure.

7. A computer-based method for upgrading firmware of a printed circuit board being performed by a processor of a microcontroller of the printed circuit board, the method comprising:
determining a firmware of the printed circuit board (PCB) to be upgraded according to an update code in an update request received by a radio frequency (RF) device when the microcontroller of the PCB is in an update mode;
receiving an update file of the determined firmware from a server via the RF device; and
upgrading the determined firmware according to the update file of upgrading the determined firmware, and uploading a result to the server via the RF device.

8. The method as described in claim 7, before the determining block comprising:
determining if the microcontroller is in the update mode according to an electrical level of a control signal wire which connects the microcontroller with a super input/output (IO).

9. The method as described in claim 8, further comprising:
determining the microcontroller is in the update mode if the PCB is powered on and the electrical level of the control signal wire is in a high level or if the PCB is powered off and the electrical level of the control signal wire is in the high level; and
determining the microcontroller is not in the update mode if the PCB is powered on and the electrical level of the control signal wire is in a low level or if the PCB is powered off and the electrical level of the control signal wire is in the low level.

10. The method as described in claim 7, wherein the result comprises confirmation of upgrading success or upgrading failure and reasons of the upgrading failure.

11. A non-transitory storage medium having stored thereon instructions that, when executed by a processor, cause the processor to perform a method for upgrading firmware of a printed circuit board, the method comprising:
determining a firmware of the printed circuit board (PCB) to be upgraded according to an update code in an update request received by a radio frequency (RF) device when the microcontroller of the PCB is in an update mode;
receiving an update file of the determined firmware from a server via the RF device; and
upgrading the determined firmware according to the update file, and uploading a result of upgrading the determined firmware to the server via the RF device.

12. The non-transitory storage medium as described in claim 11, before the determining block comprising: determining if the microcontroller is in the update mode according to an electrical level of a control signal wire which connects the microcontroller with a super input/output (IO).

13. The non-transitory storage medium as described in claim 12, further comprising:
determining the microcontroller is in the update mode if the PCB is powered on and the electrical level of the control signal wire is in a high level or if the PCB is powered off and the electrical level of the control signal wire is in the high level; and
determining the microcontroller is not in the update mode if the PCB is powered on and the electrical level of the control signal wire is in a low level or if the PCB is powered off and the electrical level of the control signal wire is in the low level.

14. The non-transitory storage medium as described in claim 11, wherein the result comprises confirmation of upgrading success or upgrading failure and reasons of the upgrading failure.
